(19) United States
(12) Patent Application Publication
(10) Pub. No.: US 2010/0125467 A1
(43) Pub. Date: May 20, 2010

(54) SYSTEM AND A METHOD FOR COMMUNICATION BETWEEN A TRAVEL PLANNING APPLICATION AND A HOTEL BOOKING PROVIDER

(76) Inventor: TATIANA BURGUETE ESPINDOLA, Ladenburg (DE)

Correspondence Address: SAP AG, 3410 HILLVIEW AVENUE, PALO ALTO, CA, 94304, US

(21) Appl. No.: 12/273,586

(22) Filed: Nov. 19, 2008

(51) Int. Cl. G06Q 10/00

(52) U.S. Cl. 705/5

(57) ABSTRACT

Described herein is a system and a method for communication between a travel planning application and a hotel booking provider, using standard interfaces compliant with OpenTravel Alliance (OTA) specification for electronic exchange of business information among all sectors of the travel industry. The standard interfaces allow the integration of hotel booking providers supporting different booking processes. The interfaces are implemented in an exchange infrastructure (XI), which is a part of an enterprise resource planning (ERP) solution. The communication between the travel planning application and the hotel booking providers is accomplished by extensible markup language (XML) messages exchanged over simple object access protocol (SOAP).

### FIELD OF THE INVENTION

The field of the invention relates generally to software, and particularly, but not exclusively, relates to communication between a travel planning application and a hotel booking provider.

### BACKGROUND OF THE INVENTION

Travel planning over the Internet is a popular concept, comprising a number of online services, such as trip and cruise planning, bus, rail, and flight booking, hotel reservations, car rental, etc. Currently, there are four main travel planning systems in operation, commonly known as Global Distribution Systems (GDSs)—Amadeus, Galileo, Sabre, and Worldspan. The GDSs communicate with travel planning applications via remote function calls (RFCs). The RFC is a procedure for data interchange between a client and a server. RFCs have a fixed set of importing and exporting parameters and fixed parameter types. The calls have to be specific to the travel planning system they are communicating with; therefore, there has to be a group of unique calls corresponding to each travel planning system connected to a travel planning application.

The disadvantages of such a technique are numerous. All RFCs are specific to the travel planning system used. Each new GDS interface released has to be implemented, which increases the time and costs for developing compatible travel planning applications. Thus, changes in the interfaces due to corrections or to adopt new functionality provided by the GDS cannot be implemented in timely manner and has to be postponed for future releases. This means that the rollout of new functionality cannot respond to the market speed requirements, making branding and customizing of travel applications a troublesome and time consuming process.

### SUMMARY OF THE INVENTION

Described herein is a system and a method for communication between a travel planning application and a hotel booking provider, using standard interfaces compliant with OpenTravel Alliance (OTA) specification for electronic exchange of business information among all sectors of the travel industry. The standard interfaces allow the integration of hotel booking providers supporting different booking processes. The interfaces are implemented in an exchange infrastructure (XI), which is a part of an enterprise resource planning (ERP) solution. The communication between the travel planning application and the hotel booking providers is accomplished by extensible markup language (XML) messages exchanged over simple object access protocol (SOAP).

### BRIEF DESCRIPTION OF THE DRAWINGS

A better understanding of the present invention can be obtained from the following detailed description in conjunction with the following drawings, in which:

FIG. 1 is a block diagram of a system for communication between a travel planning application and a hotel booking provider, in accordance with an embodiment of the present invention.

FIG. 2 is an example of an integration scenario illustrating a plurality of interfaces, designed to exchange messages between an exchange infrastructure and a hotel booking provider, in accordance with an embodiment of the present invention.

FIG. 3 is a flow diagram of a process exchanging messages between a travel planning application and a hotel booking provider, in accordance with an embodiment of the present invention.

FIG. 4 is an example of a user interface of a travel planning application, supporting one step booking process, in accordance with an embodiment of the present invention.

FIG. 5 is an example of a user interface of a travel planning application, supporting more than one step booking process, in accordance with an embodiment of the present invention.

FIG. 6A is an example of an extensible markup language (XML) query message sent to a hotel booking provider to inquire hotel availability at a specific location and time, in accordance with an embodiment of the present invention.

FIG. 6B is an example of an XML response message sent by a hotel booking provider in response to a hotel availability query message, in accordance with an embodiment of the present invention.

FIG. 6C is an example of an XML query message sent to a hotel booking provider to inquire room rates of a specific hotel at a specific time, in accordance with an embodiment of the present invention.

FIG. 6D is an example of an XML response message sent by a hotel booking provider in response to a room rates query message, in accordance with an embodiment of the present invention.

FIG. 6E is an example of an XML response message sent by a hotel booking provider containing a temporary booking ID needed for room booking, in accordance with an embodiment of the present invention.

FIG. 6F is an example of an XML confirmation message sent by a hotel booking provider in order to confirm a reservation, in accordance with an embodiment of the present invention.

### DETAILED DESCRIPTION

Embodiments of a system and a method for communication between a travel planning application and a hotel booking provider are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “this embodiment” means that a particular feature, structure, or characteristic described in connection with the embodiment is included in at least one embodiment of the present invention. Thus, the appearances of the phrases “in one embodiment” or “in this embodiment” in various places throughout this specification are not necessarily all referring to the same embodiment. Furthermore, the particular features, structures, or characteristics may be combined in any suitable manner in one or more embodiments.

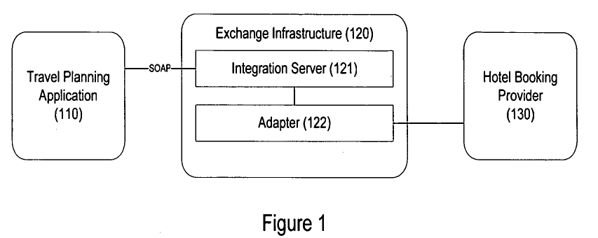

FIG. 1 is a block diagram of a system for communication between a travel planning application and a hotel booking provider. The travel planning application 110 serves as an end-user interface, providing a plurality of hotel booking services. The travel planning application 110 exchanges extensible markup language (XML) commands with the integration server 121 via simple object access protocol (SOAP). The integration server 121 is a part of the exchange infrastructure (XI) 120, which provides connectivity to a plurality of hotel booking providers. The integration server 121 processes the XML command received from the travel planning application 110 and forwards the command to the appropriate adapter 122. The adapter 122 communicates with the hotel booking provider 130, designated to execute the XML command. Once the command is executed, the hotel booking provider 130 sends back a response to the XI 120 via the corresponding adapter 122. The integration server 121 processes the response and forwards it to the travel planning application 110.

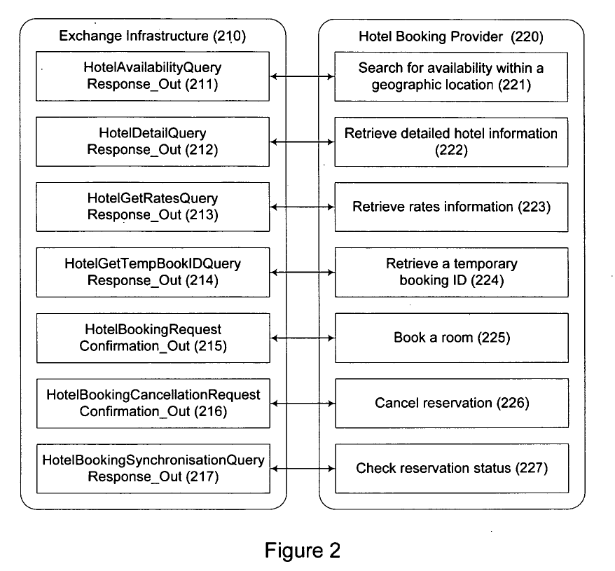

FIG. 2 is an example of an integration scenario illustrating a plurality of interfaces, designed to exchange messages between an exchange infrastructure and a hotel booking provider. In this embodiment, the plurality of interfaces, designed to exchange messages between the exchange infrastructure 210 and the hotel booking-provider 220, includes:
HotelAvailabilityQueryResponse_Out (211). This interface is used to query the availability information for multiple hotels based on a destination name (e.g. city or region name) or geographical coordinates. The response contains a list of available hotels and rooms, or a list of possible locations.
HotelDetailQueryResponse_Out (212). This interface is used to inquire a description for a single hotel. The description is a text string that contains various hotel details, provided by the hotel vendor.
HotelGetRatesQueryResponse_Out (213). This interface requests a rate list for a single hotel. This interface is only needed for hotel vendors which require the hotel rates to be requested separately during the booking process.
HotelGetTempBookIDQueryResponse_Out (214). This interface requests a temporary booking ID from the hotel vendor for a single rate. This interface is only needed for hotel vendors which require a temporary booking ID during the booking processes.
HotelBookingRequestConfirmation_Out (215). This interface is used to book a selected hotel room at a specified rate.
HotelBookingCancellationRequestConfirmation_Out (216). This interface is used to cancel a reservation.
HotelBookingSynchronisationQueryResponse_Out (217). This interface retrieves the hotel booking status. It is used to synchronize the currently displayed status in the travel planning application in case the status has been updated.

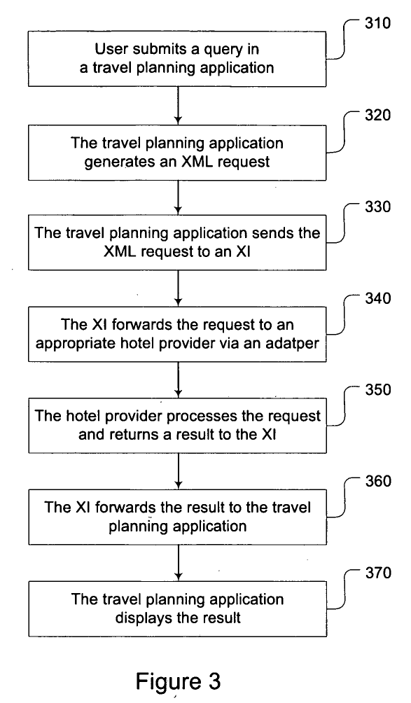

FIG. 3 is a flow diagram of a process exchanging messages between a travel planning application and a hotel booking provider. At block 310, the user submits a hotel reservation query in the travel planning application 110. The travel planning application 110 generates an XML request from the hotel reservation query at block 320 and sends the XML request to the XI 120 over SOAP at block 330. At block 340, the integration server 121 forwards the XML request to the hotel booking provider 130 responsible for processing the reservation query. The XML request is forwarded by the corresponding adapter 122. At block 350, the hotel booking provider 130 processes the XML request and returns a XML message to the XI 120 as a result. The XI 120 forwards the returned XML message to the travel planning application 110 at block 360′. At block 370, the travel planning application 110 displays the result in user readable manner.

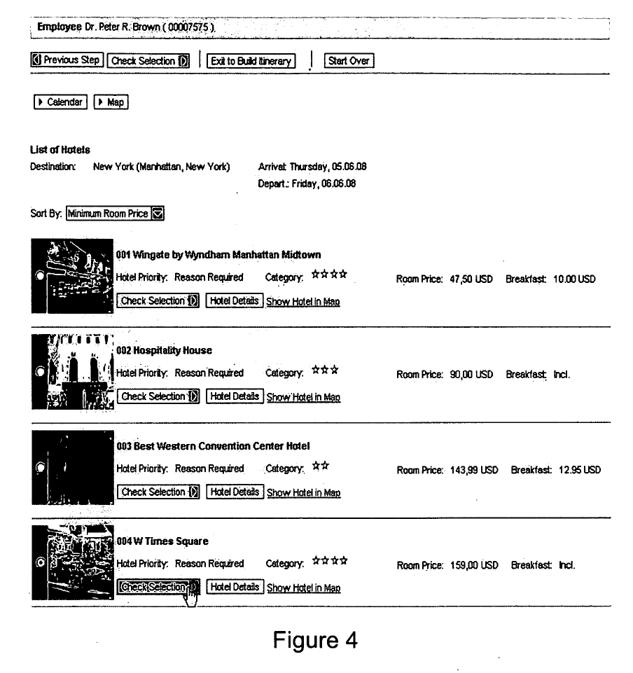

FIG. 4 is an example of a user interface of the travel planning application 110. In this example, the travel planning application 110 supports a one-step booking process. “One-step booking” is a process allowing a hotel room booking once the room is announced to be available by the hotel booking provider 130. The user has previously entered his travel destination: New York (Manhattan, N.Y.) and his arrival and departure dates: Thursday, May 6, 2008 and Friday, Jun. 6, 2008. The process described in reference to FIG. 3 above has returned a list of available hotels in the specified destination during the specified time period. Each entry in the displayed list of available hotels contains the hotel name, category and room price. Additional details are provided on demand if the user clicks the Hotel Details button. The user may continue with the booking process once he selects a hotel from the list.

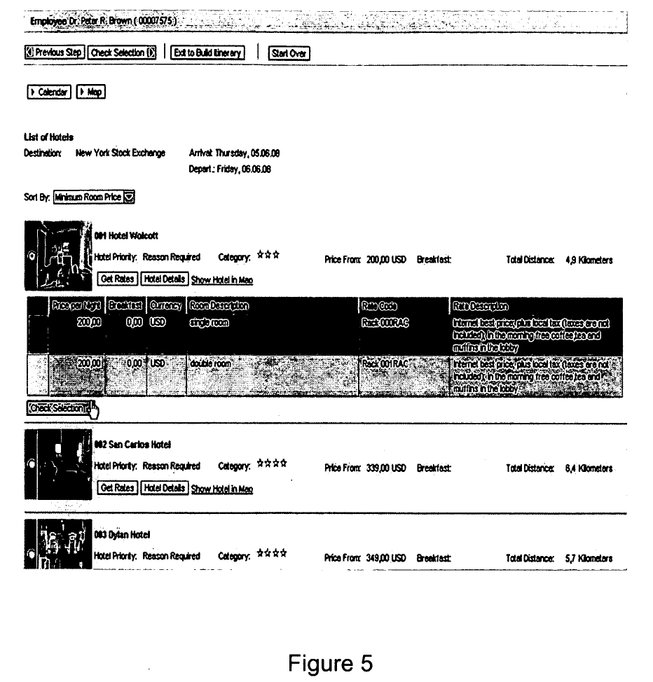

FIG. 5 is another example of a user interface of the travel planning application 110. In this example, the travel planning application 110 supports more than one-step booking process. “More than one-step booking” is a process that requires that the user selects a room rate before booking a room. The room rates are displayed in a table beneath the selected hotel after the user clicks the Get Rates button. The room rates table contains, for example, the following information: price per night, is the breakfast included or how much does it cost, the type of the currency, a room description, a rate code, and a rate description. The user may continue with the booking process once he selects a rate from the rate table.

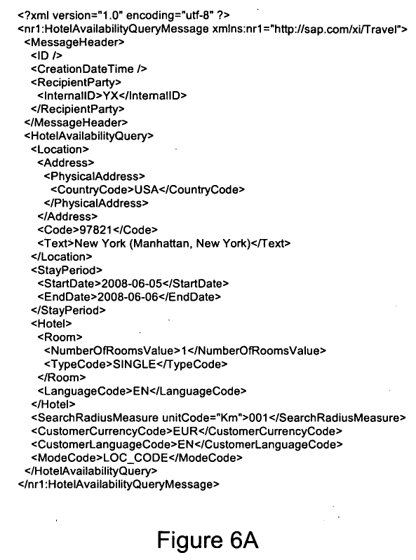

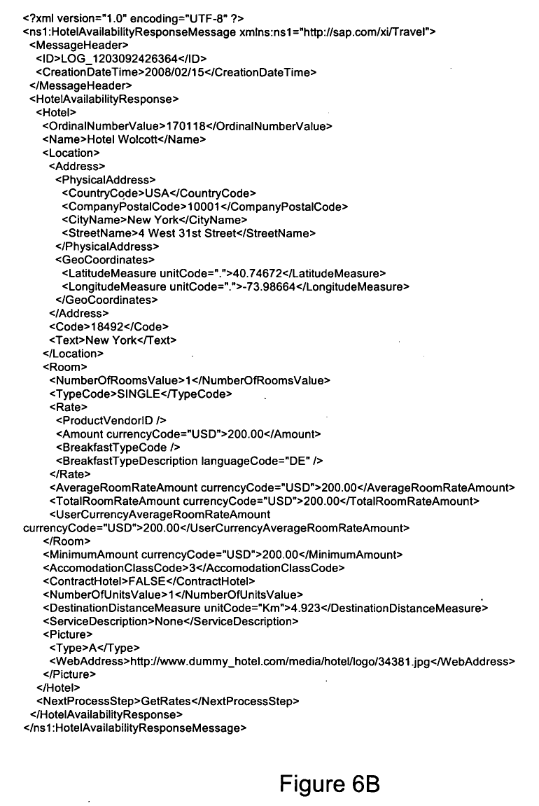

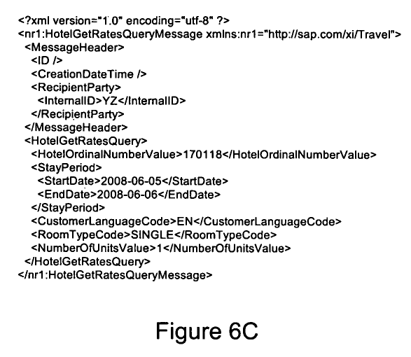

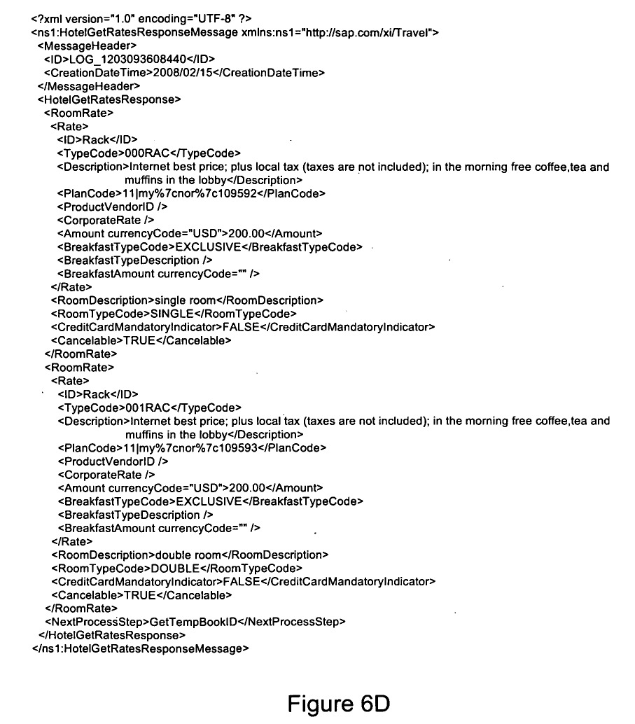

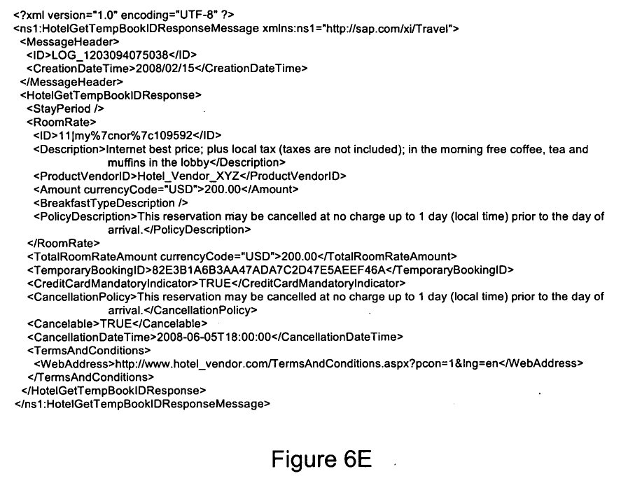

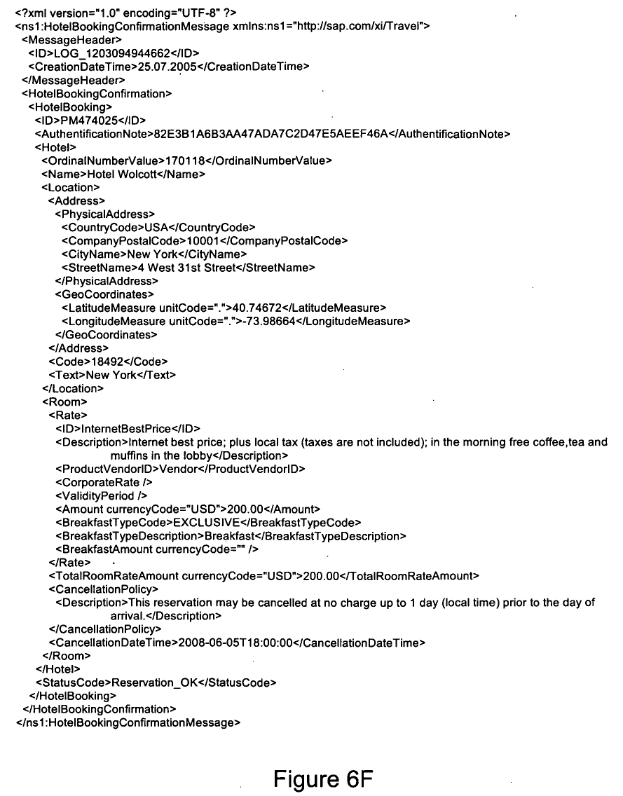

FIG. 6A is an example of an XML query message sent to a hotel booking provider to inquire about hotel availability at a specific location and time. The HotelAvailabilityQuery tag contains the following sub-tags that define the body of the query:
Location. This tag contains the user preferences for the desired hotel location. The country code is specified in sub-tag Address. The area code is specified in sub-tag Code and the Text sub-tag contains additional information about the location in plain text.
StayPeriod. This tag contains as sub-tags the start and end dates of the stay, supplied by the user.
Hotel. This tag contains as sub-tags the number and type of rooms the user wants to book for the specified period.
SearchRadiusMeasure. This tag specifies the radius of the area where the user wants to stay in. Its attribute unitCode specifies the radius measurement units.
CustomerCurrencyCode. The user requires the information about room rates to be received in the currency specified in this tag.
CustomerLanguageCode. The user requires the hotel availability information to be received in the language specified in this tag.

FIG. 6B is an example of an XML response message sent by a hotel booking provider in response to a hotel availability query message. The Hotel tag, which is a sub-tag of the HotelAvailabilityResponse tag, contains the following sub-tags that define the body of the response:
Name. The name of the hotel found by the hotel booking provider that suits the user's query message.
Location. This tag contains as sub-tags information details about the hotel's location, such as physical address, geographical coordinates, and area code. It may also contain contact details, such as phone number, fax number, and an e-mail address.
Room. This tag contains information about the available rooms that suit the user requirements. In case of one-step booking process, this tag contains a sub-tag Rate with additional information about the room rates. This tag also contains sub-tags specifying the average and total room rate amounts in user specified and local currency.
DestinationDistanceMeasure. This tag specifies the distance to the hotel in the measurement units, specified in the unitCode tag attribute.
Picture. This tag specifies a web address, containing a hotel picture.

The sub-tag NextProcessStep of the HotelAvailabilityResponse tag indicates the next step expected by the hotel booking provider. In case of one-step booking process, the next step specified is Book, which indicates that the user should proceed with booking. In case of more than one-step booking process, the next step specified is GetRates, which indicates that the user should send a room rates query message, described in reference to FIG. 6C below.

FIG. 6C is an example of an XML query message sent to a hotel booking provider to inquire about room rates of a specific hotel at a specific time. The tag HotelGetRatesQuery contains the following sub-tags that define the body of the room rates query:
StayPeriod. This tag contains as sub-tags the start and end dates of the stay, supplied by the user.
CustomerLanguageCode. The user requires the hotel availability information to be received in the language specified in this tag.
RoomTypeCode. This tag specifies the type of the room, e.g. “single” or “double”.
NumberOfUnitsValue. This tag specifies the number of rooms the user wants to book.

FIG. 6D is an example of an XML response message sent by a hotel booking provider in response to a room rates query message. The RoomRate tag, which is a sub-tag of the HotelGetRatesResponse tag, contains the following sub-tags that define the body of the response:
Rate. This tag contains several sub-tags: Description sub-tag contains information about the services included in the price in plane text, the Amount sub-tag contains the room price in the currency specified by the currencyCode tag attribute, and a plurality of sub-tags describing details regarding the included breakfast.
RoomDescription. This tag contains a room description in plain text, e.g. “single room” or “double room”.
RoomTypeCode. This tag specifies the type of the room, e.g. “single” or “double”.
CreditCardMandatoryIndicator. This tag indicates if a credit card is required.
Cancelable. This tag indicates if the reservation can be cancelled.

In this example, there are multiple RoomRate tags. Each one of them corresponds to a different room rate complying with the room rates query. The sub-tag NextProcessStep of the HotelGetRatesResponse tag indicates the next step expected by the hotel booking provider. If the hotel booking provider requires a temporary booking ID, the value of the NextProcessStep tag is GetTempBookID.

FIG. 6E is an example of an XML response message sent by a hotel booking provider containing a temporary booking ID needed for room booking. The HotelGetTempBookIDResponse tag contains the following sub-tags that define the body of the temporary booking ID response:
StayPeriod. This tag contains as sub-tags the start and end dates of the stay, supplied by the user.
RoomRate. This tag contains several sub-tags: Description sub-tag contains information about the services included in the price in plane text, the ProductVendorID sub-tag contains the name of the hotel, the Amount sub-tag contains the room price in the currency specified by the currencyCode tag attribute, the BreakfastTypeDescription sub-tag describes details regarding the included breakfast, and the PolicyDescription sub-tag describes details regarding the reservation policy.
TotalRoomRateAmount. This tag contains the price of the room.
TemporaryBookingID. This tag contains the temporary booking ID supplied by the hotel booking provider.
CreditCardMandatoryIndicator. This tag indicates if a credit card is required.
CancellationPolicy. This tag contains information in plain text regarding the cancellation policy.
Cancelable. This tag indicates if the reservation can be cancelled.
CancellationDateTime. This tag contains the date and time when the reservation will be automatically cancelled if not confirmed.
TermsAndConditions. This tag specifies a web address containing terms and conditions of the hotel.

FIG. 6F is an example of an XML confirmation message sent by a hotel booking provider in order to confirm a reservation. The HotelBooking tag, which is a sub-tag of the HotelBookingConfirmation tag, contains the following sub-tags that define the body of the response:
AuthentificationNote. This tag contains the temporary booking ID received with the temporary booking ID message, described above.
Hotel. This tag contains all available information about the room reservation in its sub-tags, as follows:
   Name. The name of the hotel found by the hotel booking provider that suits the user's query message.
   Location. This tag contains as sub-tags information details about the hotel's location, such as physical address, and contact details, such as phone number, fax number, and an e-mail address.
   Rate. This tag contains several sub-tags: Description sub-tag contains information about the services included in the price in plane text, the Amount sub-tag contains the room price in the currency specified by the currencyCode tag attribute, and a plurality of sub-tags describing details regarding the included breakfast.
   TotalRoomRateAmount. This tag contains the price of the room.
   CancellationPolicy. This tag contains information in plain text regarding the cancellation policy.
   CancellationDateTime. This tag contains the date and time when the reservation will be automatically cancelled if not confirmed.
StatusCode. This tag contains the status code of the completed hotel booking process.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A computer-implemented method executing on a processor for communication between a travel planning application and a hotel booking provider, comprising:
retrieving a hotel booking request from a travel planning application, the travel planning application executing on a client computer, wherein the hotel booking request represents an extensible markup language (XML) message;
forwarding the hotel booking request to a server computer of a hotel booking provider;
receiving a result from the hotel booking provider; and displaying the result in the travel planning application.

2. The method of claim 1, further comprising:
searching a hotel within a specific geographic region;
acquiring detailed information about a hotel;
acquiring information about room rates;
if the hotel booking process requires a temporary booking ID, retrieving a temporary booking ID;
booking a hotel room;
cancelling a hotel room reservation; and
synchronizing information displayed in the travel planning application with the currently available information at the hotel booking provider.

3. (canceled)

4. The method of claim 1 wherein the result from the hotel booking provider represents an XML message.

5. The method of claim 1 further comprising transporting hotel booking requests and results via exchange infrastructure (XI) using simple object access protocol (SOAP), wherein XI comprises:
an integration server to receive hotel booking requests from the travel planning application; and
an adapter to connect to the hotel booking provider responsible to process the hotel booking requests.

6. A computer system including at least one processor for executing program code, comprising:
a travel planning application executing on a client computer to provide hotel booking services;
a hotel booking provider on a server computer to process hotel booking requests and to generate results, wherein the hotel booking requests and the generated results represent extensible markup language (XML) messages; and
an exchange infrastructure (XI) to exchange hotel booking requests and results between the travel planning application and the hotel booking provider.

7. The system of claim 6 wherein the exchange infrastructure comprises:
an integration server to receive hotel booking requests from the travel planning application; and
an adapter to connect to the hotel booking provider responsible to process the hotel booking requests.

8. A machine readable medium having a set of instructions stored therein which when executed cause a machine to perform a set of operations comprising:
retrieving a hotel booking request from a travel planning application, wherein the hotel booking request represents an extensible markup language (XML) message;
forwarding the hotel booking request to a hotel booking provider;
receiving a result from the hotel booking provider; and
displaying the result in the travel planning application.

9. The machine-readable medium of claim 8, further comprising:
searching a hotel within a specific geographic region;
acquiring detailed information about a hotel;
acquiring information about room rates;
if the hotel booking process requires a temporary booking ID, retrieving a temporary booking ID;
booking a hotel room;
cancelling a hotel room reservation; and
synchronizing information displayed in the travel planning application with the currently available information at the hotel booking provider.

10. (canceled)

11. The machine-readable medium of claim 8 wherein the result from the hotel booking provider represents an XML message.

12. The machine-readable medium of claim 8 further comprising transporting hotel booking requests and results via exchange infrastructure (XI) using simple object access protocol (SOAP), wherein the XI comprises:
an integration server to receive hotel booking requests from the travel planning application; and
an adapter to connect to the hotel booking provider responsible to process the hotel booking requests.
